(19) United States
(12) Patent Application Publication
(10) Pub. No.: US 2022/0374708 A1
(43) Pub. Date: Nov. 24, 2022

(54) SYSTEM AND METHOD FOR CONTENT AUTOMATED CLASSIFICATION

(71) Applicant: Keepcon Corporation, Wilmington, DE (US)

(72) Inventors: Dan Gabriel Rozenfarb, Caba (AR); Matias Egea, Olivos (AR)

(21) Appl. No.: 17/747,967

(22) Filed: May 18, 2022

Related U.S. Application Data
(60) Provisional application No. 63/189,875, filed on May 18, 2021.

(51) Int. Cl. G06N 3/08

(52) U.S. Cl. CPC G06N 3/08

(57) ABSTRACT

The system and method for content automated classification includes a method having the steps of receiving a piece of content composed of at least one field; parsing each field of the piece of content according to the field structure in the configuration; computing a field interpretation per field, the field interpretation based on configuration, the field interpretation comprising an ordered list of tokens and a dictionary of attribute-value pairs assigned to each token; computing labels by the labeling subsystem, the labeling based on applying a trained procedure to compute labels the pair of piece of content and content interpretation, the content interpretation comprising the field interpretations; and computing at the class assignment subsystem one or more classes from the classification taxonomy based on the content, labels and field interpretations.

### CROSS-REFERENCE TO RELATED APPLICATIONS

This application claims the benefit of U.S. Provisional Patent Application Ser. No. 63/189,875, filed May 18, 2021, entitled “SYSTEM AND METHOD FOR CONTENT AUTOMATED CLASSIFICATION,” which is incorporated by reference herein in its entirety.

### FIELD OF THE INVENTION

The present invention relates to computer-automated content interpretation.

### BACKGROUND OF THE INVENTION

Today content is generated across the internet, on social media, over private computer networks, and other forms of communication every minute. In the modern Internet era it has been strategic for companies, organizations and certain actors to understand content that was or is being generated in the web, be it social media, message boards or other of many forms of electronic communication.

User-generated content can be directly associated to an entity—a person, company or organization—or it can tangentially acknowledge them, e.g., by referring to them (or mentioning them). Content sources may include social media (including, but not limited to, Twitter, Instagram, Facebook), chat applications (e.g., included in a web application), or even different types of files, such as those encoding documents and audio recordings. These contents vary in format, are written in different languages, contain incorrect syntax or grammar, replace some characters with look-alike characters, et cetera.

We take for granted the human brain's capacity to understand text even when it is not straightforwardly written. For example, when a unicode character resembling the letter A, such as A, replaces this letter, any person reading the text will easily understand what is written while a computer program may ignore the word or have difficulty understanding what's there. Another complexity arises when words are conjugated. Consider the word “estúpido” (stupid in Spanish) which can be written in two genders (masculine, feminine) and singular or plural, creating four possible versions of this word. If we add suffixes the number of possibilities goes to 40; if we add prefixes it goes to 640; if we play with the syntax, make phonetic replacements (e.g., replacing s for z) there are 19,200 possibilities; and if a user camouflages there writing (e.g., “est.tu.pi.do”), among other tricks, we get over 38 million ways to write this word. All of these can be immediately understood by the human brain.

Creating a computer program with the capacity to understand properly written text is a difficult task in and of itself. When the additional complexity of writer manipulation is added into the mix, a computer program that captures and classifies all of these texts seems intractable, and far from straightforward.

Parallelly, content classification varies depending on the ulterior use of the classification. If a kid's forum receives the message “This game is a load of crap”, it will almost certainly be rejected; yet the same content may be perfectly permissible in an adults forum. Hence, business rules differ from actor to actor, and encoding these differences is yet another problem to be solved.

The following are examples of how the system and method for content understanding is used in applications:

### Moderation

Throughout the years, message boards, forums, and other collaboration services have benefited from moderation. Moderation in its most primitive form is tasked with deciding whether a piece of content (e.g., a message) is allowed for publication or not. Historically, moderation involved at least one human reading through every entry and deciding whether to approve or reject the content. This is, undoubtedly, time-consuming and prone to several kinds of errors and bias. Therefore, there is a need for an automated classification process, which is a problem that has not been solved effectively.

### Monitoring/Listening

When a company is mentioned on social media or any forum, there is often an interest in understanding what these messages are about—are they complaining, making a suggestion, or praising the organization? Closely linked to this, is having a better understanding of who the author of the message is, including but not limited to what is their gender, age, and location, allowing an organization to make an informed analysis over their online community. This requires the automated classification of content, which is again an unsolved problem.

### Customer Service

Companies can answer questions and requests from their online community through a specially-purposed web application or social media. Often the company may task different teams to answer different types of questions, as for example, a cable operator may have a technical team and an administration team answering questions. The messages coming from these users should then be triaged and rerouted to the corresponding team or department within the company. Historically, a person acting as an operator would route messages to the corresponding team after interacting with the client, or even answer some questions. This is again an unsolved classification problem which could be automated.

### Chatbot

Companies use chatbots to answer questions from their customers or subscribers (users). Chatbots handled by humans suffer from deficiencies such as an uneven service and logistic difficulty of maintaining a service 24/7, among other concerns. Companies can therefore profit from a content understanding service that allows them to classify these questions and provide prepared answers; or eventually route the questions to a specific customer service team when appropriate.

Therefore, there is a need in the industry for these shortcomings to be addressed.

### SUMMARY OF THE INVENTION

Embodiments of the present invention provide a system and method for automated content understanding. The system contains a content interpreter subsystem, a labeling subsystem, class assignment subsystem, a configuration including a content source, a field structure, a classification taxonomy (comprising a hierarchy of classes) and optionally a training dataset. The method includes: receiving a piece of content composed of at least one field; parsing each field of the piece of content according to the field structure in the configuration; computing a field interpretation per field, the field interpretation based on configuration, the field interpretation comprising an ordered list of tokens and a dictionary of attribute-value pairs assigned to each token; computing labels by the labeling subsystem, the labeling based on applying a trained procedure to compute labels the pair of piece of content and content interpretation, the content interpretation comprising the field interpretations; and computing at the class assignment subsystem one or more classes from the classification taxonomy based on the content, labels and field interpretations.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram illustrating logic within a computer having the functionality of the present system and method.

FIG. 2 is a flowchart illustrating steps performed by the present system and method.

FIG. 3 is an example of a piece of content being a Tweet.

FIG. 4 is a flowchart illustrating exemplary steps performed by the content interpreter.

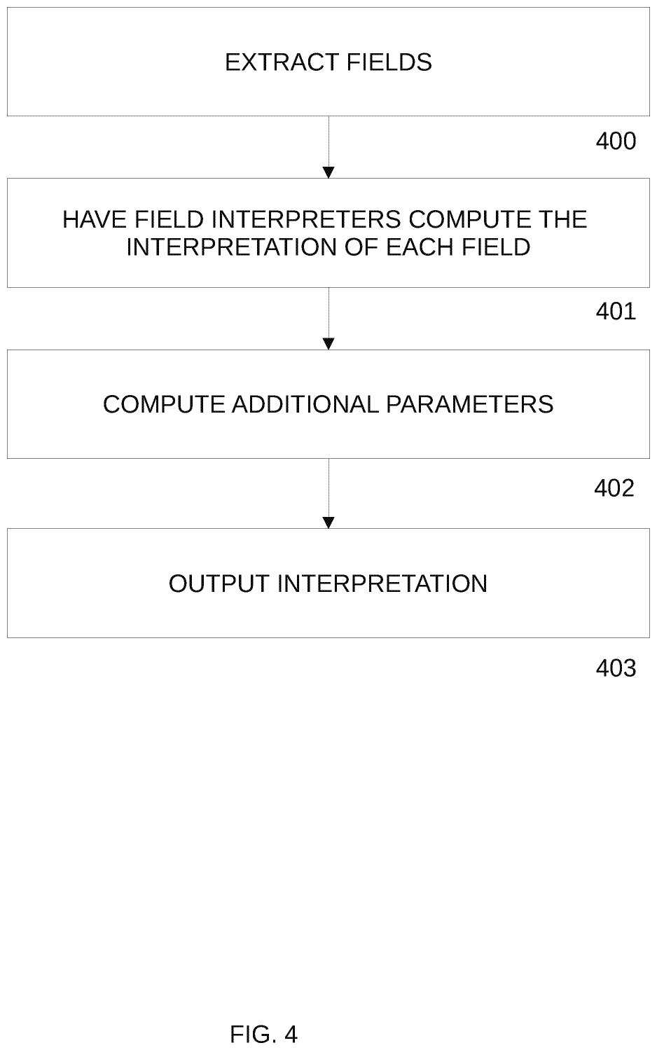

FIG. 5 is a flowchart further illustrating exemplary steps within the classification process.

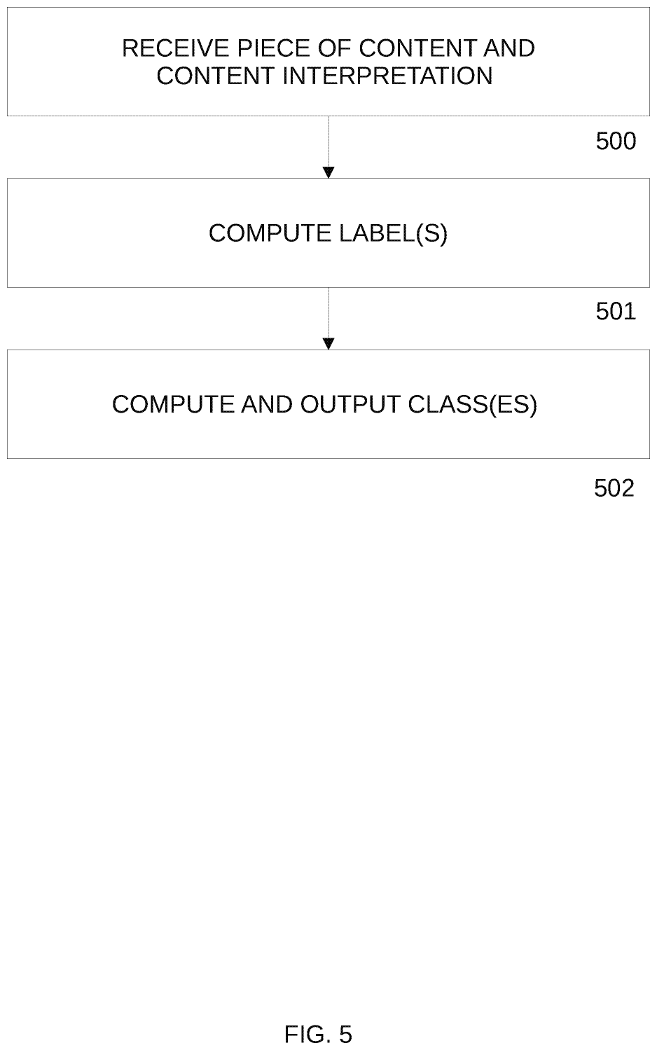

FIG. 6 is a schematic diagram illustrating the present system in accordance with a second exemplary embodiment of the invention.

### DETAILED DESCRIPTION

The present invention provides a system and method for automatically classifying content which addresses the problems associated with the prior art. One means to provide a solution to the shortcomings of the prior art is through automated computer content understanding, as is provided by the present system and method.

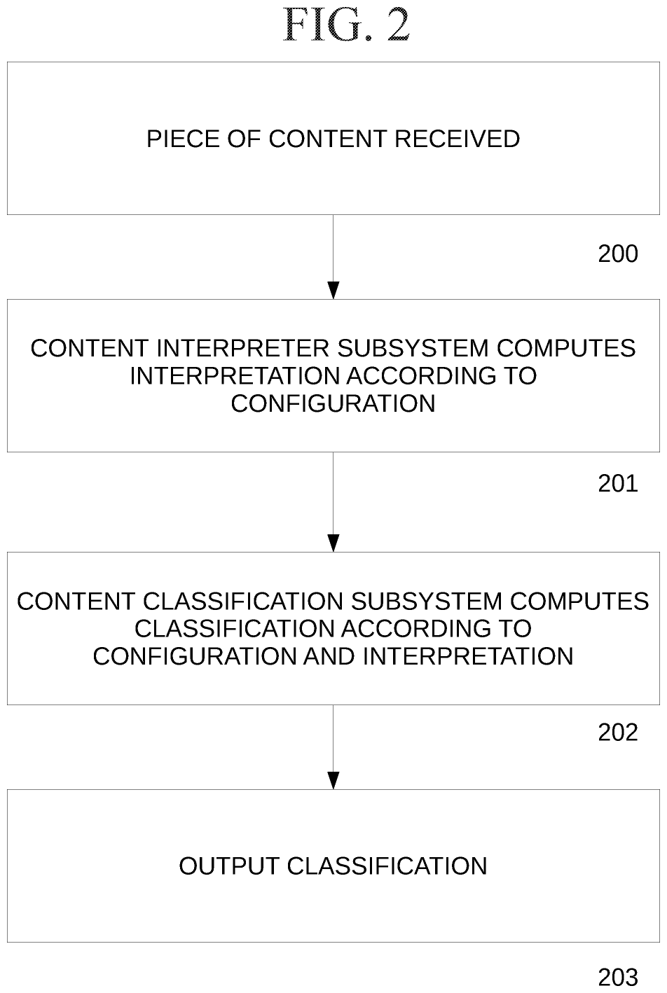

A company or organization, hereafter an organization, facing the previously mentioned shortcomings may require a content classification service. That is, a service which classifies content automatically and at least solves one or more of the problems of moderation, monitoring and listening, chatbot and customer service described earlier. It is an object of the present invention to classify pieces of content according to a configuration. Here, the pieces of content may be, but are not limited to, a series of tweets from Twitter, a series of Facebook messages, a series of files within a folder in a filesystem, and more. A configuration (106) is data, which may be stored in one or more files, a database or other storage, and includes a description for the source of the content (e.g., Twitter, Facebook, the filesystem) and a classification taxonomy comprising a set of classes. Once set up (with the configuration), as illustrated by the flowchart of FIG. 2, every time the content understanding service receives a piece of content from the configured source, it computes the classes (from the classification taxonomy) to which the piece of content is associated with. FIG. 2 is described in additional detail herein. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

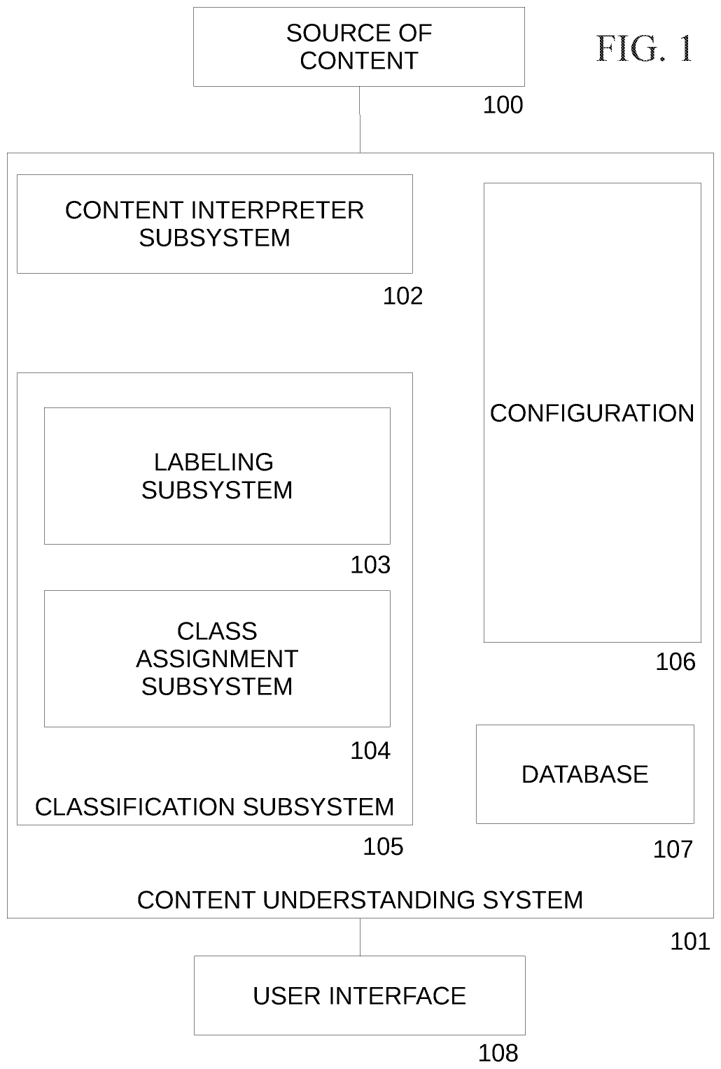

FIG. 1 is a schematic diagram illustrating logic within a computer having the functionality of the present system and method. For exemplary purposes, each portion of logic herein has been provided a name, however, it should be noted that this does not mean that the logic having a specific name is only capable of performing the functionality associated with the name of the logic. As shown by FIG. 1, the system contains a content interpreter subsystem (102), a classification subsystem (105) which includes a labeling subsystem (103) and a class assignment subsystem (104), a database (107), and a configuration (106) which may be stored in the database or separate. Each of these is explained in detail herein. The content understanding system (101) receives or pulls, as someone skilled in the art may understand, pieces of content from the source of content (100). For example, the system may be iterating over files in a folder for a filesystem, or pulling twits from Twitter. Once the piece of content is received, the content interpreter subsystem (102) computes an interpretation for this piece of content. Using the interpretation, the classification subsystem (105) may assign one or more classes (class tags) to the piece of content and recor this in the database (107). To do this, the classification subsystem first has the labeling (sub)subsystem (103) assign labels to the piece of content and interpretation, and then has the class assignment (sub)subsystem (104) produce the class tags.

The output, consisting in piece of content and class tags, is recorded in the database (107) and may be output as described in the configuration (108). For example, when the system is used in moderation, it may happen that an application is waiting for a boolean (True or False) to decide whether the content may be published or rejected; then this is output to the moderation external system. A user interface may be provided via a web application as is standard in the art. Other examples may format and communicate the output differently as it is standard in the art. It should be noted that other configurations may be provided, for example, but not limited to, wherein data storage may instead be remote, or via a file system instead of a database, or there may be no user interface.

As shown by the flowchart of FIG. 2, in a first embodiment of the present invention, the content understanding system (or engine) (101 FIG. 1) retrieves or receives a piece of content from a source of content (100 FIG. 1) block 200. For example, system 100 FIG. 1 may be a queue service including a queue of pieces of content, or a database, or a filesystem. Alternatively, the content understanding engine 101 may include a mechanism to retrieve a new piece of content. These pieces of content may be retrieved by an external procedure. One having ordinary skill in the art would understand how different retrieval procedures can be used. The following provides exemplary use of a queue system.

Next, in a first stage, a content interpretation is computed by a content interpreter subsystem (block 102) according to configuration (106). The configuration, accessible to subsystem 102, may be stored in a database (107), or a filesystem. In a second stage, the interpretation is used to assign one or more classes in the classification taxonomy included in the configuration (block 106) to the piece of content by a classification subsystem (block 202) (also block 105). The output of the present content understanding system 101 is the assignment of classes to the piece of content (FIG. 2, 203), also referred to herein as classification. This output, or classification, (203) may be stored in a database (block 107) or other form of storage.

The following definitions are useful for interpreting terms applied to features of the embodiments disclosed herein, and are meant only to define elements within the disclosure.

As used within this disclosure, a source of content may be a social media service, including but not limited to a Facebook Chat (or other Facebook app), Twitter, Instagram, messages received on a web forum, or messages received through a web application chat. The source of content may also be any form of storage, e.g., a file system, that can hold files representing video recordings, audio recordings and written documents.

As used within this disclosure, a piece of content may be associated with a message sent over a social network, web application, or other networked service. Moreover, a piece of content may be formatted as a text document, a printable document, a video or a voice recording and includes a structure that is specific to the source of content and repeated in every piece of content from the same source. (Say, all pieces of content from the Facebook source have the same format.)

As used within this disclosure, a piece of content may contain several different content fields (or fields for short) and may be assigned properties, including but not limited to: header, body, footer, sender, message, timestamp, language, street address, telephone number, email address, subject, geolocation, topic or thread, an image, a video, or audio recording, and other fields depending on the source (e.g., a Twitter tag identifying if the underlying tweet is a retweet).

As used within this disclosure, a classification taxonomy consists in class tags (the classes) and parent-children relationships between these classes. Two classes need not be comparable.

As used within this disclosure, a class may encompass mentions to a specific product for a company, a subclass may include mentions of a feature of this product, which again may have subclasses describing the sentiment of the mention: positive, neutral or negative. The company may have also defined a geographic classification in which a class may be “USA”, subclasses may include the 50 states, and subclasses of these may include counties or big cities. Needless to say, the classes “Hawaii” and the product feature class are not comparable.

As used within this disclosure, a field interpretation is basically the interpretation of a field. A field interpretation consists of:

a list of tokens, and for each token
a dictionary consisting in a list of attribute-value pairs. Attributes include type, text, start (number of the character in the text string where this token starts) and end (analogous to start). Other attributes may be conditional to the field (e.g., if it is a user field or a text field), and even to the type of the token. Here ‘type’ describes a type of the token, including but not limited to text, URL (uniform resource locator), emoji, phone number and date. For example, when the type is ‘text’, the attributes include
   Concept,
   morpho-syntactic information (gender, number),
   Language.
A token of the type ‘URL’ may include a domain attribute and a “full URL” attribute. Other token types include, but are not limited to, emoji, date, number.
Every token to type text has a language token which includes a (possibly empty) list of languages, and for each language a number from 0 to 1 which indicates the estimated probability that the token belongs to that language.

As used within this disclosure, an attribute may be paired with an empty value, or one or more values. Attribute-value assignments are computed by procedures. For example, a procedure receiving the token “cake” may produce two values for the ‘concept’ attribute: one for the noun and one for the verb. Moreover, each attribute may have sub-attributes, and even these sub-attributes have sub-sub-attributes in a tree structure. For example, in an exemplary run of the invention the token “deberias” (Spanish for you should) has the attribute “interpretations” which includes a list of two interpretations, each having as attributes “MSI (morpho-syntactic information)” and other attributes, MSI having as attributes “gender”, “number” and more.

As used within this disclosure, a configuration includes references to one or more sources of content, a classification taxonomy and possibly other entries. These entries may include training data, or even a training step, as defined later. For each source of content, the configuration includes a parsing specification which allows a parsing procedure to extract fields from every piece of content from the specified sources of content.

In an exemplary run, the source of content is a Twitter username. Each tweet either mentioning or created by this username is retrieved and fed to the content understanding service. As all twitter messages, retrieved through the Twitter API (application programming interface) share the same fields and structure, the field structure needs to be specified once. The configuration includes a specification of this field structure that allows a parser to parse the different fields of a tweet (piece of content), e.g., username, timestamp, text, and the ‘is retweet’ flag.

The configuration further specifies the type of each field, which may include, but are not limited to, name, timestamp, text or even a custom field. The field type is later used to determine which field interpreter processes the underlying field, e.g., a text (field) interpreter is used to produce the interpretation of a field of type text.

Another item within the configuration is that of a classification taxonomy. That is, the names of the class tags and the trees or hierarchies for them. Moreover, the configuration may include training data comprising a set of pieces of content and the classes they correspond to.

This classification of the training data may be done manually or even provided externally to the system, say, by the client consuming the content classification service; e.g., a list of messages that should be rejected in a content moderation application.

Yet another item in the configuration includes an execution pipeline configuration which specifies for each field type, an ordering of procedures (described below) so that the execution pipeline following this order can produce an interpretation of a field value. Default execution pipelines have been configured within the system for common uses, e.g., text in English.

### Stage 1 of 2: Interpretation

In an embodiment of the present invention the content interpretation subsystem receives a piece of content and produces an interpretation (201). The content interpretation subsystem (102) is configured according to configuration (106).

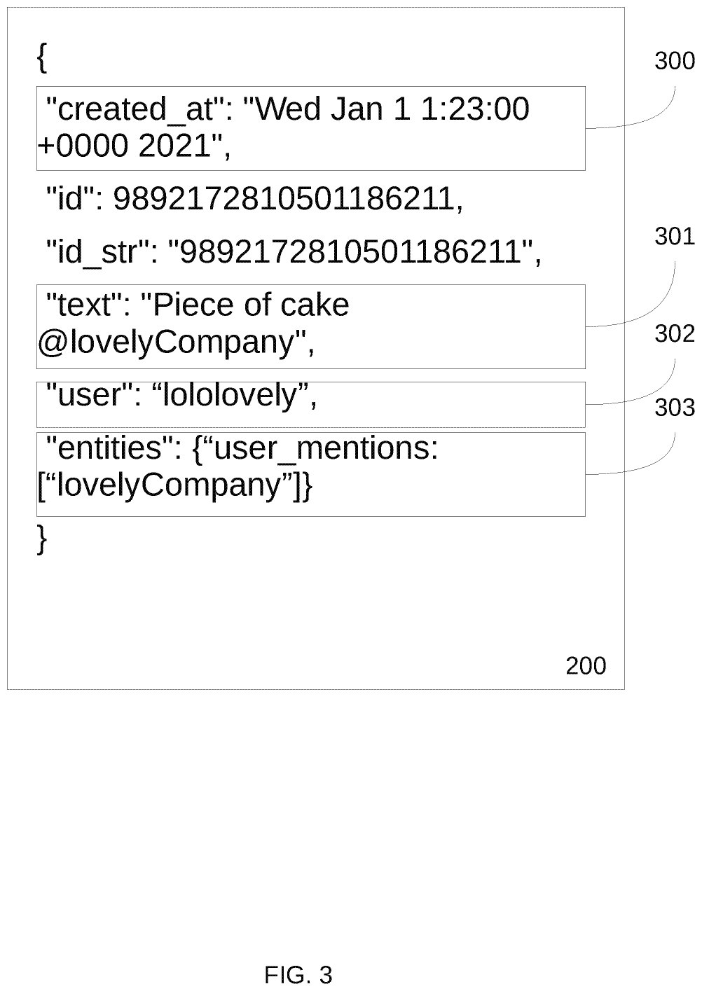

In an exemplary run, the piece of content (200) is a Tweet depicted in FIG. 3 which represents a tweet created by user @lololovely at 1:23 AM (GMT) of Jan. 1, 2021 with the text “A piece of cake @lovelyCompany” and mentions the user @lovelyCompany.

This configuration specifies the fields of the content in a way that it allows the subsystem to extract the value of each field. In the case of the example, it specifies the user field, a ‘created at’ field, a text field, and an entities field, which in turn includes a user mentions field. This may be depicted by exemplary FIG. 3 where four fields are specified (300, 301, 302 and 303). Notice that these fields are provided as an example, other fields may be present in this or other sources of content.

According to the first embodiment of the present invention the content interpretation subsystem (102) extracts the fields from the piece of content using the parsing specification included in the configuration. This first task is done by standard field extraction mechanisms and according to that which one having ordinary skill in the art would understand, e.g., the piece of content is provided in a pre-specified format, including but not limited to, the Extensible Markup Language (XML) or JavaScript Object Notation (JSON). Alternatively, the piece of content is atomic (e.g., a text file or a string) and the fields are extracted through parsing techniques that are known in the art. Note that, having fixed the source of content, the fields and extraction procedures need to be fixed once for all the pieces of content originated from this source.

In an exemplary run, the content interpreter (102) is configured to extract each of the fields (400) out of the piece of content. In an exemplary run, fields (300), (301), (302) and (303) are extracted. It further assigns a field type to each field according to this configuration; for example, the “created_at” field (300) is of type timestamp, the “text” field (301) is of type text, the “user” field (302) is of type twitter user or user, and the “entities” field (303) is of type entities (i.e., a custom interpreter that is used for this specific field on twitter).

According to the first embodiment of the present invention, once the fields have been extracted each field is processed by the specific field interpreter (401) underlying the type of the field. For each type, a field interpreter is specifically configured. Each field interpreter receives a field for its configured type from the piece of content and returns the interpretation of this field.

Additionally, the content interpreter may compute more parameters (402) associated with the content, including but not limited to, language probability estimations of the content. Language probability estimations comprise a list of languages and the probability (a number between 0 and 1) that the piece of content belongs to that language. This is done by retrieving the ‘language’ attribute for all the tokens in the interpretation and applying a probability-estimation algorithm, if languages are enumerated as i=1, 2 and 3, then the probability of language 1 is

SUM_{t is token}p[i][t]/(NUMBER OF TOKENS)

where the sum is over all the tokens and p[i][t] is the probability that token t belongs to language i.

Once the field interpretations for each field have been computed and these additional parameters have been computed (if any is configured), the content interpretation subsystem outputs the content interpretation which consists in field interpretations and additional parameters.

Field interpreters are configured specifically for each field in the piece of content including, but not limited to a text field interpreter, a user field interpreter, a timestamp field interpreter, an entities field interpreter, and a ‘is retweet’ field interpreter.

A field interpreter is configured by an execution pipeline and the configuration underlying the procedures which conform the execution pipeline. An execution pipeline for a field interpreter consists in a tree of specially-tasked procedures that generate and update a field interpretation; a field interpreter takes a field value (extracted from the piece of content) and produces an interpretation of this field. The execution of the execution pipeline is called the execution tree.

Given a field, the execution pipeline is configured according to an execution pipeline configuration to take the (input) field as a token (hereto contents of the field are an example of a token), run a first procedure which is associated to the root node in the execution pipeline in order to obtain a first token interpretation. A token may be a word, a sentence, a clause, an emoji, and more generally a token is an instance of a sequence of characters in some particular document that are grouped as a semantic unit for processing.

The interpretation pipeline configuration includes a sequence of procedures. Once a procedure associated with a step in the sequence has run and produced an interpretation for that token, the following procedure in the sequence is executed by the execution interpreter. Each procedure can be configured with a precondition, where a precondition is code that evaluates over the (partial) field interpretation that has been computed thus far. If the procedure does produce an interpretation and this is the last step in the sequence, then the execution stops and the field interpreter outputs the interpretation. A procedure may produce more than one possible interpretations for a token, when this happens each of the interpretations is evaluated independently. A tree of possible interpretations opens. Say the second procedure in the execution pipeline produced five possible interpretations for a token, then the third procedure (and the remaining of the sequence) runs in each of these five interpretations. If at any point in these five independent evaluations, one of the procedures determines its preconditions are not met, then this branch of the tree is eliminated. Moreover, if at some point an interpretation modifies the token, by splitting it in two or more tokens, by concatenating it with another token or by any other transformation (as described below), then the whole execution pipeline runs from the start on the newly generated tokens (in each of the tokens).

The following describes what is a procedure and provides non-limiting examples.

### Procedures

Each procedure may require configuration parameters that need to be defined in the configuration for the execution pipeline, including a precondition.

Before running a procedure, the execution pipeline evaluates if the configured precondition is met; the procedure is only run if the precondition is met. A precondition may be a formula which receives the input field, the interpretations which have been computed thus far by the execution pipeline and returns True or False. Alternatively, a precondition is evaluated using code that reads as input the input field and already-computed interpretations. If the precondition is not met, the procedure does not run and the underlying execution pipeline branch terminates without output. Examples of preconditions include, but are not limited to, deciding whether a specific attribute (e.g., gender or number) is present in the interpretation received from the predecessor node, deciding whether the value of a specific attribute within the interpretation being bigger than a given constant, or that the field has an attribute named ‘type’ with the value ‘verb’.

The first token interpretation (i.e., the interpretation computed by the procedure associated with the root of the execution tree) may consist in the same token it received and its (token) interpretation, or an ordered list of tokens and the interpretations of these tokens.

A procedure may receive one token and produce two or more tokens. Say, a token may include text consisting in several words, and the procedure may be tasked with parsing the text into words, so that each word is a token and the output of this interpreter includes these tokens and each token is associated with the set of interpretations computed for the token. After a procedure (associated with a node) finishes, the field interpretation has been updated and the execution pipeline may run all of the node's children.

The following lists some procedures that are configured into the execution pipeline. These focus on specific aspects of the written language.
A lexer receives a text and produces a set of tokens. A lexer, for example, may divide a text into sentences or clauses, by splitting the text in every dot character (full stop). A lexer may comprise a neural network that has been trained to split sentences for a specific language and content source. Someone skilled in the art may define other implementations for a lexer either using artificial intelligence techniques or using statistical inference.
A grammar interpretation procedure assigns a basic type to a text, for example, it may recognize a character to be of the emoji type, or a sequence of characters including 0-9 to be a number, or a date, or an email. These types are given as an example; and anyone skilled in the art should understand that other types may be defined. The types may need configuration and be specific to the locale of the content source. For example, dates are formatted differently in different countries or regions. Again, this procedure may be implemented using machine learning, other artificial intelligence techniques, and may include a dictionary of words and their types.
Post-Interpretation procedure can find token constructions including entities, sentences, clauses and blocks with meaning. It thus splits the input into each of these parts. Again, this procedure may be implemented using machine learning, or other artificial intelligence techniques.
A normalizer transformation (procedure), for example, normalizes the characters in a attribute by producing a new version in which all characters that are graphically similar to the character ‘a’ are replaced with the character ‘a’, and similarly with other characters that compose the English alphabet (or another language, based upon settings). The normalizer interpreter may also, for example, map unicode characters to the preselected alphabet, and even apply hard-coded rules (e.g, replace the Æ character with AE). This is a special example of a transformation; transformations are discussed below. This may be implemented with an algorithm that maps any character in an alphabet to an ascii character. Someone skilled in the art can infer other implementations of this procedure.
Splitter and merger interpretation procedures: These procedures typically run after other procedures have run. They are tasked with splitting and merging (word) tokens. For example, the token “I.am” may become the tokens “I am”, the tokens “Ian” and “guage” or the token “lan.guage” may become “language” and “stu pid” becomes “stupid”; or, when the language is configured to Spanish, the token “no.thing” may be split, depending on the context, or not. It may refer to “nothing” or it may refer to the two words “no” and “thing”. These interpreters are implemented using one of the two following techniques: using heuristics; or statistical training that can be specific to a language or client project. For example, an heuristically-trained splitter and merger may be trained to split the text “yessir” into the pieces “yes” and “sir” as it is common for users in this source of content to mistake “yessir” for “yes sir”. Again, this procedure may be implemented using machine learning, other artificial intelligence techniques, and may include a dictionary of words and their types. The procedure may compute one or more alternatives for a given input. For example, the token ‘I.am happy’ may receive an interpretation where the attribute ‘sentence’ has the value “I am happy” (one sentence) and the value “I” and “Am happy”. (In this case, a procedure which comes next may probably eliminate the second two-sentence alternative leaving only “I am happy”.)

A procedure, such as those above, may be compound in the sense that it consists of executing a combination of (simple or compound) interpreters, e.g., the locale interpreter may include a currency interpreter and a date interpreter.

A special and important procedure is the token interpretation procedure.

### Token Interpretation Procedures

Tokens interpretation procedures add interpretations to tokens. One example of a token interpretation procedure is the concept interpretation procedure. The following provides a more thorough description of token interpretation procedures.

When the token consists of one word, a special subset of procedures may be applied.
A number parser recognizes numbers, e.g, given the string “banana” it has an empty output, and given the string “1,629 50” it outputs the number 1629.50. This parser may be implemented, for example, by a simple arithmetic algorithm with branches.
A text to number parser, whose purpose is evident from the name, will interpret the string “six” as the number 6. Again, this may be implemented using artificial intelligence, statistical inference, dynamic programming or any other standard technique as it should be evident to someone skilled in the art.
A verb interpretation procedure receives verbs in any conjugation and returns their infinitive form. This may be implemented, for example, by including a list of verbs in their infinitive form and with rules for transforming any verb to its infinitive form. The procedure will then apply these transformations (perhaps more than one in a row) until its output is in the list of infinitive verbs. If this does not happen, it returns nothing.
A date interpretation procedure, based on a configured locale, will convert all string forms in which a string may encode a date, into a date. For example, the preferred format for dates may be defined as “YYYY-mm-dd”, meaning for digits for the year, two for month and two for day number, separated with dashes; so that “Dec. 25, 2020” is converted to “2020-12-25”. This procedure is standard in the art and requires no further description.
A locale interpretation procedure identifies and parses addresses, dates or times and telephone numbers based on the preconfigured client's locale. This procedure may is a compound procedure and includes the address procedure, the date procedure, et cetera.

The execution interpreter may produce a field interpretation by running (at some point in the execution) a token interpretation procedure on each of the tokens that were produced in an earlier interpretation entry. As an example, the text “The p4t3nt will issue βy tomorrow” may be processed by some procedures as follows:
1. First procedure: “The p4t3nt will issue βy tomorrow” (one token)
2. Normalize by alphabet interpretation procedure: produces an interpretation that includes the attribute ‘text’ with value “the patent will issue by tomorrow” (one token).
3. A grammar lexer procedure: produces the list of tokens [“the”, “ ”, “patent”, “ ”, “will”, “ ”, “issue”, “ ”, “by”, “ ”, “tomorrow”] (ten tokens).
4. A normalizer transformation: produces the list of tokens [“the”, “ ”, “patent”, “ ”, “will”, “ ”, “issue”, “ ”, “by”, “ ”, “tomorrow”] (ten tokens).

Eventually, the execution pipeline calls the concept Interpretation procedure which takes each of the tokens (words) and looks up in a concepts dictionary for these tokens. In particular, it finds the token “issue” and retrieves the values “issue (verb)” and “issue (noun)”. Hence, the interpretation for the token ‘issue’ has an attribute ‘concept’ with these two values.

### The Concept Interpretation Procedure

The concept interpretation procedure receives a token of type text and adds one or more values to the concept attribute of this token's interpretation. A concept interpretation procedure may apply any one of lexical, graphical, or phonetic transformations, or subsets of these. As an example a concept interpreter, configured for Spanish, may go from “gugl3adoras” to “google”. It will also compute the correct spelling of the word, “googleadoras”, determine the concept “googleador”, with the basic concept “google”, and morpho-syntactic traits of Noun, femenine plural, and further include the transformations that lead from the original word to each of these.

Each item is described by a lemma, the transformations that go from the original token to the concept (the lemma), and some properties that are derived during the transformations. Examples include:
given the tokens “dogs” and “doggie” the concept interpreter finds the lemma “dog” for both, and further derives the gender and number of these nouns.
The interpreter also computes from the word “known” the concept “know”, which is a verb, and that it is given in the past participle conjugation.

The concept interpreter works by successively applying transformations to tokens, looking up the results (of these transformations) in a dictionary which is part of the configuration, and adding the concept when a match is found. The concept interpreter thus defines a transformation-execution pipeline for this matter. Transformation examples include but need not limit to the following.
Lemmatizations: Nominal, adjectival and verbal lemmatizations (Lemmatisation, or lemmatization, in linguistics is the process of grouping together the inflected forms of a word so they can be analysed as a single item, identified by the word's lemma, or dictionary form. (Last accessed 2021 Apr. 15, https://en.wikipedia.org/wiki/Lemmatisation)),
Enclitics (In morphology and syntax, a clitic is a morpheme that has syntactic characteristics of a word, but depends phonologically on another word or phrase. In this sense, it is syntactically independent but phonologically dependent—always attached to a host. ( . . . ) An enclitic appears after its host. (https://en.wikipedia.org/wiki/Clitic#Classification. Last checked 2021 Apr. 15)),
Derivations (in Spanish, googleador->googlear->google). Morphological derivation, in linguistics, is the process of forming a new word from an existing word, often by adding a prefix or suffix, such as un- or -ness. For example, unhappy and happiness derive from the root word happy. (https://en.wikipedia.org/wiki/Morphological_derivation. Last checked 2020 Dec. 11.)
Phonetic and graphic transformations: Graphical transformations are those that replace one character by a graphically “similar” character—similarity being subjective. Examples, including, but not limited to, replacing “p4t3nt” for “patent” or more even replacing the character q (the armenian small letter za) with the character q representing the latin letter q (as in question), or the greek β by b.

Generally speaking, these transformations are implemented by simple rules, artificial intelligence or statistical inference. The training or configuration of these, thus, depends on the language and particularities of those writing the pieces of content (e.g., if they use slang, jargon or have distinctive habits). Needless to say, most of these mechanisms can be applied, mutatis mutandis, to other languages; hence the teachings introduced herein may apply to other languages without limitations to the ones included specifically in this text.

The OCF (orthographically correct form) is established once a match is found. For example, if phonetic or graphical transformations are applied, a dictionary match is found, then the concept is added as a possible token interpretation and the OCF is included.

As an example, a transformation may be tasked with transforming a token given in the plural to its singular form. For example, in English, removing a final character “s” may turn a plural into a singular. For example, dogs is the plural of dog. There are other transformations in English that could turn a plural into its singular including, but not limiting to, removing the final “es” in a word, as for example, removing them from octopuses to produce the singular octopus. The transformation thus attempts both of these changes (removing a final ‘s’ and removing final ‘es’, if possible) and checks if the result is found in a dictionary of words in their singular form. If successful, it returns the singular form and the transformation leading to the success; else it returns nothing.

Analogously one may turn a Spanish femenine “tonta” (dumb) into the masculine “tonto” by replacing the “a” with an “o”. Again, there are a handful of transformations that may change the gender of an adjective. These may be then included as lemmatisations consumed by the concept interpreter.

An interesting example in Spanish comes from the token “googleadoras”. This word may be transformed to the singular “googleadora”, then to the masculine “googleador”, then to the verb “googlear”, and then to the noun google.

Also, the token “race” produces at least three different concept interpretations including the following.
1. Noun. Each of the major groupings into which humankind is considered to be divided on the basis of physical characteristics or shared ancestry.
2. Noun. A competition between runners, horses, vehicles, et cetera.
3. Verb. Compete with another or others to see who is fastest at covering a set course
   Verbal transformations attempt to transform a conjugated verb into the infinitive. Some languages, including but not limited to Spanish, English, Portuguese and French, have regular verbs which have the characteristic that their conjugations are produced by a handful of rules.

### Other Procedures

A Statistical interpretation procedure is a procedure, trained on a corpora, that helps with tokens producing more than one concept or words producing no concept. Several statistical interpreters may be developed and put to use.

In an exemplary run of content interpretation, at some point in the execution pipeline a first statistical interpreter runs. It receives the interpretations produced (or inherited) by its parent, and if a token does not include a valid concept, this statistical interpreter runs on this token. It is programmed with transformations, e.g., to fix common typing errors based on statistics. For example, it may take the token “Noencontrenada” (respectively “Ifoundnothing”) and try to split the word into two or more words and apply a pipeline of interpreters to decide whether the transformation makes sense. In this case, it picks at least one possible splitting which is returned to the pipeline. In an exemplary run, it returns “no encontré nada” (respectively “I found nothing”), and after this the interpreter pipeline continues to run, it computes concepts for these three words and assigns a positive probability to this being the correct spelling. Eventually, the statistical interpreter adds the interpretation entry with the new tokenization (in which the one token Noencontrenada/Ifoundnothing are replaced by the three tokens “No encontre nada”/“I found nothing” and the interpretation of each of the tokens.

Disambiguation problems may also be solved by a second statistical interpreter; this one trained with a different corpora and features that we call the Language Disambiguation interpretation procedure. When a token included in earlier interpretation entries has two or more concept entries, the language disambiguation interpreter may remove one of these. This interpreter is trained with phrases so that it can detect common and improbable concept sequences. For example, when an interpreter, earlier in the pipeline, computes two or more concepts for a token (word), this statistical interpreter may remove one of these as being improbable. As an example, the sentence:

He won the race.

Two of the three concepts for race introduced in the above example may be removed, when the corpora includes the same sentence or a small variation of it.

A sentence delimiter interpretation procedure detects full stops and other symbols used to delimit sentences. A pipeline including the sentence delimiter may also include the sentence extractor interpreter, which detects the sentences in the text. It produces the “sentences” attribute in the interpretation.

A contractions interpretation procedure is tasked with transforming contracted words into their uncontracted form. While in Spanish there are only a few contractions, “del” the contraction of “de el” and “al” the contraction of “a el” being the most common, there are many contractions in French, English, and Portuguese. For example, in English, the contraction transformation maps aren't to are not, can't to cannot, 'cause to because, et cetera.

An Edit Distance interpretation procedure is trained with sentences (not just words) and the correct lemmas and forms of each token. The Edit Distance Interpreter is configured with a distance, say 2, then a token is fed into this interpreter and compared with the words in a training set. If any of the words in the training set are at distance of two or smaller from the original (i.e., they differ in two characters or less), and the word sequence for both match, then the interpreter “edits” the original token by replacing it with the one from the training set. This interpreter is often used together with the first statistical interpreter (introduced above) to generate possible splits.

Given a piece of content language probability estimation produces a list of languages and the estimated probability that the text of a field belongs to that language (say, Spanish 77%, English 23%). The language probability distribution is computed as an aggregate of the language probability estimations for each of the tokens. In language processing: “Given a character sequence and a defined document unit, tokenization is the task of chopping it up into pieces, called tokens, perhaps at the same time throwing away certain characters, such as punctuation.” (“Introduction to Information Retrieval,” by Christopher D. Manning, Prabhakar Raghavan and Hinrich Schütze; Cambridge University Press; Website: http://informationretrieval.org/). A token is but may not be limited to a word, an e-mail, a number, a hashtag, a clause, a sentence.

Examples of aggregation include the mean, median, and other techniques which are known in the art. Field examples include, but are not limited to, user, username, text, mentions, email, and timestamp. Language probability estimation requires certain information that is computed during the interpretation, so it may run when this information is available.

### Stage 2 of 2: Classification

According to the present embodiment of this invention, the content classification subsystem receives a piece of content and a content interpretation and computes a possibly empty set of classes (202) that are associated with this piece of content and outputs the classification (203). This is done by the following steps.
First receiving the piece of content and content interpretation (500):
Next, the content interpretation is assigned labels by the procedure (the labeling subsystem 103) to compute labels (501). Labels may be produced by a Pattern Matching procedure, a Statistical Classification procedure, an artificial Intelligence Procedure or other labeling procedures. One such procedure receives the content interpretation and produces labels. These procedures may be configured and trained during the configuration stage.
In a second step (502), the piece of content, its interpretation and assigned labels are processed by the class assignment subsystem 104. For each class in the taxonomy there is a procedure, which may be a logical formula or a deep-learning procedure, is used to decide whether a piece of content belongs or not to this class. When the content is found to belong to the class, a class tag is applied.
Classes (class tags) are returned as output. This output may be thus consumed by the application, e.g., content moderation, chatbot, or other. The system may thus insert an item in the database pairing the piece of content with these class tags. Moreover, a web application may allow system users to query this database and obtain information about pieces of content and their classes as its standard in the art.

In one embodiment of the present invention the labeling assignment (501) is implemented as a pattern matching procedure. A pattern matching procedure is configured to receive a pattern, generated during configuration and encoded in a specially-designed language, and a content interpretation and return True or False depending on whether there is a pattern match. Each pattern is associated with a label. When there is a match, the label is associated with the content interpretation (or the underlying piece of content).

An example of a pattern, encoded in this specially-designed language, follows.
Ord: hacer, exp_masDeTiempo|exp desdeHaceTiempo|exp_pasoXTiempo
Extra 1
   This pattern matches any ordered sequence of tokens as follows. If any of the conditions below is not satisfied, then the pattern matching for this label returns False.
a. Starts with a token which includes the concept attribute with the value “hacer” (“to do” in English).
b. If the immediately followed a text matching any of the pattern expressions: _masDeTiempo, _desdeHaceTiempo, or _pasoXTiempo (different Spanish expressions which could be translated to “for a long time”, “since some time ago”, “some time has passed”). These three patterns need to be defined as well. For example, the pattern _pasoXTiempo can be defined by the pattern Ord: pasar, number, tiempo. Extra 1 since:
   i. The concept “pasar” (verb) in the past form
   ii. Any integer number
   iii. The pattern “tiempo”, which in turn may encompass the concepts “tiempo” or the specific words “horas”, “dias”
   iv. The “extra 1” modifier means that there may be one, and only one, additional token in the text and it will still match
   For example, the text “Pasó un horroroso dia” matches the pattern _PasoXTiempo since “Pasó un dia” has the concept “pasar” followed by a concept interpreted as an integer number, followed by the word “dia” which is matched by the pattern time.

According to this language, a comma-separated list of patterns prepended with “Ord:” means that the first pattern needs to match a first portion of the text, then the second pattern and so on until all the patterns have been satisfied. If the Extra: 1 modifier appears, this means that there may be any one token placed arbitrarily and should be ignored.

More generally, the above pattern describes a condition which is met if, and only if, the two conditions are met (a and b above), the token matching the set of tokens matching the first condition and those matching the second condition are in the order “a” before “b” and optionally have a token in between. Each of the two conditions may be evaluated individually. One of these pattern matching conditions may be simple, as it happens with a, or may be defined by other pattern matching conditions, as it happens with b. In case one condition is not simple, there may only be a finite set of conditions defining it.

Other pattern examples follow.
Label: _quisieraExtraerDinero
   Pattern: Ord: +quisiera|+necesitaria, extraer|retirar|sacar, dinero. Extra: 0
Label: +Quisiera
   Pattern+desear, hasMsi: [1: pres ind, 1 cond, 1 imperf ind]|+quiero
Label: +desear
   Pattern: +tenerGanasDe|querer|desear
Label: +tenerGanasDe
   Pattern_tenerGanasDe|_estarConGanasDe
Label: _tenerGanasDe
   Pattern: ord: +poseer, ocf: gnas, de extras: 0
Label: poseer
   Pattern: tener|poseer|_contarCon
Label: _contarCon
   Pattern: ord: contar, con
Label: dinero
   Pattern: dinero|plata|guita
      MSI stands for morphosyntactic information. The pattern matches only those verb conjugations that are included in this list.

Modifiers used to design a pattern include “lit”, which means that the literal token needs to be matched, “Ocf” (standing for Orthographically Correct Form) which means that the correct form of the token needs to be included (e.g., “tele” for “television”), “ord” and “unord” stand for an ordered and unordered sequences. One can further operate over the token type structure, so that if the token is a URL, then “URL.domainName, URL.port, and URLdomainNameWithoutCountry” equal the domain name, the port, and the domain name without country of the URL. For example, the token ‘google.com.ar’ matches the pattern URLdomainNameWithoutCountry=‘google.com’ but does not match the pattern URL.domainName=‘google.com’. More generally, the pattern definition language includes especially-defined modifiers for every token type and entity.

During the pattern-matching step, a configured set of patterns is matched. A piece of content may then receive no label, one or more labels.

In another embodiment of the present invention, an artificial intelligence (e.g., machine learning) procedure is used to produce labels. A corpora including pieces of content and labels (manually set by a process which is outside the scope of the invention) is received. The pieces of content are processed by a configured content interpreter. Next, a machine learning algorithm is trained to assign labels to a pair of (piece of content, content interpretation of this piece of content).

Other embodiments may be implemented using variations of this labeling procedure.

### Class Assignment

A piece of content, which has received its content interpretation, and has later been labeled may be classified according to a classification procedure (502) by a class assignment procedure (104). The classification procedure can be defined as a logical construct of subclasses defined by pattern matching, deep learning and other classification schemes. The classification procedure then checks for every configured class, if the piece of content falls or does not fall in this class.

For example, a classification can be set for some labels, so that if a piece of content is labeled with the “Product X” label, then it receives the “Product X” class; if it further receives the label “negative sentiment”, then it may classified as “Product X/Sentiment: negative”.

More generally, logical formulae may be defined for each class so that given any interpretation of a piece of content and the labels resulting from the pattern-matching procedure, a formula either evaluates to TRUE and the piece of content belongs to this class, or it is assigned FALSE and the piece of content does not belong to this class.

In the case of deep learning, the organization or someone acting on its behalf may have provided a set of pieces of content that have been classified through other means, say manually. Next, the interpretation stage and pattern matching procedures may be run with each of the pieces of content. So the deep learning scheme may be trained to map interpretations and pattern-match labels with classes. Once training concludes, the deep learning scheme may map any given interpreted and labeled piece of content with classes—even if the piece of content is not found in the training set.

Other classes could include conditions such as what the language is, and the classification procedure thus checks for the language attribute in the interpretation. Classifications may depend on whether a piece of content includes a certain entity, or the amount of words in a given attribute.

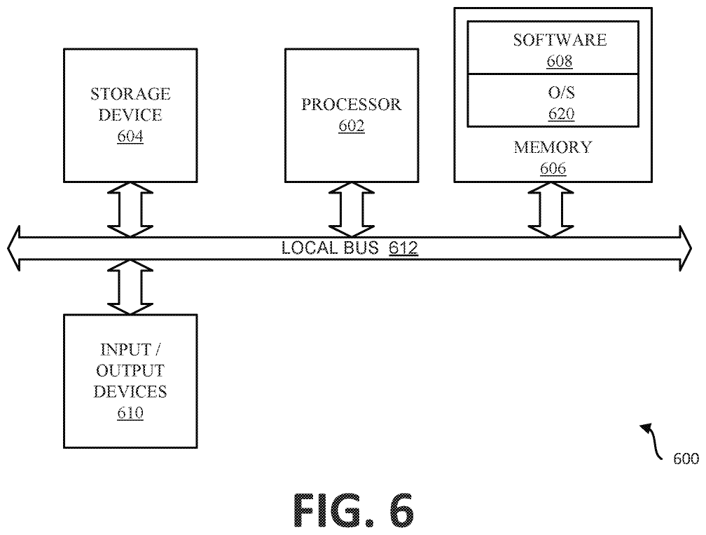

Another example of the system of the present invention may be the system of FIG. 6, which may be, for example, but not limited to, a computer. Functionality as performed by the present system and method, as previously described, is instead defined by software modules within the system 600, as opposed to logic as shown by FIG. 1. The system 600 contains a processor 602, a storage device 604, a memory 606 having software 608 stored therein that defines the abovementioned functionality, input and output (I/O) devices 610 (or peripherals), and a local bus, or local interface 612 allowing for communication within the central server. The local interface 612 can be, for example but not limited to, one or more buses or other wired or wireless connections, as is known in the art. The local interface 612 may have additional elements, which are omitted for simplicity, such as controllers, buffers (caches), drivers, repeaters, and receivers, to enable communications. Further, the local interface 612 may include address, control, and/or data connections to enable appropriate communications among the aforementioned components.

The processor 602 is a hardware device for executing software, particularly that stored in the memory 606. The processor 602 can be any custom made or commercially available single core or multi-core processor, a central processing unit (CPU), an auxiliary processor among several processors associated with the present system 600, a semiconductor-based microprocessor (in the form of a microchip or chip set), a microprocessor, or generally any device for executing software instructions.

The memory 606 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 606 may incorporate electronic, magnetic, optical, and/or other types of storage media. Note that the memory 606 can have a distributed architecture, where various components are situated remotely from one another, but can be accessed by the processor 602.

The software 608 defines functionality performed by the system 600, in accordance with the present invention, as previously described. The software 608 in the memory 606 may include one or more separate programs, each of which contains an ordered listing of executable instructions for implementing logical functions of the system 600, as described below. The memory 606 may contain an operating system (O/S) 620. The operating system essentially controls the execution of programs within the system 600 and provides scheduling, input-output control, file and data management, memory management, and communication control and related services.

The I/O devices 610 may include input devices, for example but not limited to, a keyboard, mouse, scanner, microphone, etc. Furthermore, the I/O devices 610 may also include output devices, for example but not limited to, a printer, display, etc. Finally, the I/O devices 610 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 600 is in operation, the processor 602 is configured to execute the software 608 stored within the memory 606, to communicate data to and from the memory 606, and to generally control operations of the system 600 pursuant to the software 608, as explained above.

When the functionality of the system 600 is in operation, the processor 602 is configured to execute the software 608 stored within the memory 606, to communicate data to and from the memory 606, and to generally control operations of the system 600 pursuant to the software 608. The operating system 620 is read by the processor 602, perhaps buffered within the processor 602, and then executed.

When functionality of the system 600 is implemented in software 608, it should be noted that instructions for implementing the system 600 can be stored on any computer-readable medium for use by or in connection with any computer-related device, system, or method. Such a computer-readable medium may, in some embodiments, correspond to either or both the memory 606 or the storage device 604. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 602 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device. Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where functionality of the system 600 is implemented in hardware, the functionality can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

### Revisiting Application

The system and method of the present invention can be thus used for content moderation, monitoring social media, customer service automated answers and routing, and chatbot answering, as follows.
Monitoring social media. In social media monitoring applications a training set is provided, the training set consisting in a set of pieces of content and classes. Many pieces of content may have the class. They constitute a class in the classification system, e.g., classes are assigned simply by having all the pieces of content with the same class. The system is therefore trained to classify pieces of content according to the training pieces of content and underlying classes. The content source, field structure and execution pipelines are also configured. For every piece of content received, the system proceeds as described above in order to output one or more classes. After producing the classification of a piece of content, the system returns the classes.
Content moderation: In content moderation the system is used as follows. A training set is provided, the training set consisting in a set of pieces of content that should be moderated (banned) and a classification for each example. The system is therefore trained to classify pieces of content according to these classifications and configured with a content source. Other configuration decisions are made accordingly, e.g., execution pipelines, content fields. For every piece of content received, the system proceeds as described above. After producing the classification of a piece of content, the system looks up in the table and decides if the piece of content needs to be moderated based on this lookup.
Chatbot answering: In chatbot answering applications a training set is provided, the training set consisting in a set of pieces of content and answers for each example. Many pieces of content may have the same answer. They constitute a class in the classification system, e.g., classes are assigned simply by having all the pieces of content with the same answer belong to the same class. The system is therefore trained to classify pieces of content according to the training pieces of content and underlying classes. The content source, field structure and execution pipelines are also configured. For every piece of content received, the system proceeds as described above in order to output one or more classes. After producing the classification of a piece of content, the system looks up in the table and returns the answer for the class assigned to the piece of content.
Customer service automated answers and routing application. The customer service answering service is similar to chatbot answering application with an addition. Each piece of content may be assigned a (class and) answer, but it may also be assigned a responder type. For example, a customer service in a bank may have a set of prepared answers, but may also offer clients to chat with human beings. These human beings may belong to the credit cards department, new accounts department or technical services. These departments are provided as an example, and other responder types may be possible. The customer service automated answers and routing application therefore receives a piece of content, assigns a class to this piece of content, and either returns an answer or connects the user to a responder type.

I claim:

1. A method for automated content understanding comprising a content interpreter subsystem, a labeling subsystem, class assignment subsystem, a configuration including a content source, a field structure, a classification taxonomy (comprising a hierarchy of classes) and optionally training dataset, the method comprising the steps of:
receiving a piece of content composed of at least one field;
parsing each field of the piece of content according to the field structure in the configuration;
computing a field interpretation per field, the field interpretation based on configuration, the field interpretation comprising an ordered list of tokens and a dictionary of attribute-value pairs assigned to each token;
computing labels by the labeling subsystem, the labeling based on applying a trained procedure to compute labels the pair of piece of content and content interpretation, the content interpretation comprising the field interpretations; and
computing at the class assignment subsystem one or more classes from the classification taxonomy based on the content, labels and field interpretations.

2. The method of claim 1, wherein the piece of content is selected from the group consisting of a tweet, a Facebook post or response, a PDF document, an Instagram message or post, messages within a chat application, and different text encodings.

3. The method of claim 1, wherein the field interpretation further comprises a language probability estimation.

4. The method of claim 1, wherein the classification subsystem further includes an artificial intelligence procedure, further comprising the steps of:
receiving a training dataset comprising pairs of pieces of content and taxonomy classes;
computing the interpretation of these pieces of content;
computing the labels for the pairs including these pieces of content and their interpretation;
training an artificial intelligence procedure running within the class assignment subsystem to compute the taxonomy classes from each pair consisting of a piece of content and the content interpretation of this piece of content; and
configuring the class assignment subsystem to compute the classes of a pair of a piece of content and the interpretation of this piece of content using the artificial intelligence procedure.

5. The method of claim 1 wherein the field interpretation comprises the steps of:
receiving an execution pipeline comprising a sequence of procedures, wherein each procedure receives a token and returns a list consisting of at least one tokens and a dictionary of token attributes associated with this token;
setting the field as the first token;
for each token received, executing the sequence of procedures one by one wherein each procedure execution comprises:
receiving a token and a dictionary of token attributes, evaluating if the procedure's precondition is met, and returning the received token or one or more sequences of tokens and a dictionary of token attributes for each token returned;
executing the next procedure in the sequence if the token returned is the same as the token received, or starting with the first procedure in the sequence for each of the new tokens; and
finishing if the last procedure in the sequence was evaluated; and
returning a set of lists of tokens, each token associated with a dictionary of attribute-value pairs.

6. The method of claim 5, wherein the procedures that are part of the sequence of procedures further include:
a normalizer transformation procedure replacing letters by other letters according to configured statistical information;
a splitter procedure that can split a string of characters into two strings of characters according to configured statistical information;
a merger procedure that can merge two strings of characters into one according to configured statistical information; and
a verb interpretation procedure that receives any verb and returns its infinitive form plus gender and time.

7. The method of claim 1 wherein the labeling subsystem is configured with a set of labels and logical formulas paired with each label, further comprises the steps of:
receiving a content interpretation;
receiving and evaluating a formula, wherein each term of the formula is a pattern matching procedure; and
assigning a label to the piece of content based on the result of the evaluation.

8. The method of claim 1, wherein the training dataset includes pairs of piece of content and class tag, further comprising the steps of:
producing the content interpretation for a piece of content from the training dataset;
assigning labels to the piece of content and content interpretation; and
training a neural network to assign classes to the pieces of content, the training dataset including the continent interpretation and label tags as features,
wherein the class assignment procedure comprises:
receiving a piece of content, the content interpretation and label tags for this piece of content;
predicting a class with the trained neural network from the piece of content, content interpretation and label tags; and
assigning a class tag to the piece of content based on the result of the neural network.

9. The method of claim 1 wherein the configuration further includes a set of pairs of class tag and logical formula and the class assignment procedure further comprises:
producing the content interpretation for a piece of content from the training dataset;
assigning labels to the piece of content and content interpretation; and
applying a logical formula associated with a class, the formula including variables associated with the content interpretation and labels, and assigning the class to the piece of content based upon the result of the formula.

10. A method for implementing content moderation, monitoring social media, customer service automated answers and routing, and chatbot answering, the method comprising the steps of:
configuring a source of content;
configuring a structure of fields for pieces of content from the source of content;
configuring a taxonomy of classes;
training the system to classify pieces of content; and
assigning answers to each class.
